(19) United States
(12) Patent Application Publication
(10) Pub. No.: US 2007/0211929 A1
(43) Pub. Date: Sep. 13, 2007

(54) Digital medical image processing

(75) Inventor: Gareth Richard Beddoe, London (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Medicsight PLC, London (GB)

(21) Appl. No.: 11/715,886

(22) Filed: Mar. 9, 2007

(30) Foreign Application Priority Data
Mar. 9, 2006 (GB) 0604852.4

(51) Int. Cl. G06K 9/00

(52) U.S. Cl. 382/128

(57) ABSTRACT

In a method of performing CAD analysis of a medical image, the medical image volume is processed in a pre-processing module to generate intermediate data, and the intermediate data is processed by a filtering module to generate CAD result data. The different modules may be executed by different processing nodes or devices, enabling a variety of different system architectures. The intermediate data may be stored in accordance with a standard, such as the Digital Imaging and Communications in Medicine (DICOM) standard. For instance, the intermediate data may be stored in accordance with the DICOM secondary capture image information object definition (SCI IOD) format. The CAD result data may be displayed on a viewer workstation, for example.

### CROSS-REFERENCE TO RELATED APPLICATION

This application claims the benefit of the filing date of GB Patent Application No. 0604852.4, filed Mar. 9, 2006, which is incorporated herein by reference in its entirety.

### BACKGROUND OF THE INVENTION

1. Field of the Invention

The present invention relates to computer implemented medical image processing.

2. Background Art

Medical images are a valuable tool for diagnosis, and a variety of techniques or modalities have been developed, including but not limited to X-ray, computed tomography (CT), ultrasound, and magnetic resonance imaging (MRI). Conventionally, these images have been inspected visually by trained radiographers. The images may be generated digitally (CT and MRI) or digitized from an analog image (X-ray). The digitized images may be inspected and annotated by radiographers, and the annotations stored for later retrieval and analysis.

The task of the radiographer can be made easier by storing the medical image on a computer providing a user interface which allows the user to manipulate the image and to visualize the structures contained therein in different ways. However, the process is time consuming and must be performed with great care in case any abnormalities are missed.

To replace some or all of the work of the radiologist, Computer Assisted Detection (CAD) software has been designed to analyze the medical image and detect potential abnormalities. The detection can be performed semi-automatically, with some interaction with the radiologist, or automatically, involving no interaction beyond the selection of the image to be analyzed. For example, the applicant's MedicHeart™, MedicLung™ and MedicColon™ diagnostic software perform semiautomatic diagnosis of CT scans of the heart, lung and colon, respectively.

CAD software uses one or more algorithms to analyze a given medical image. The image may be pre-processed prior to analysis, for example by segmenting the image to flag regions of interest or to remove regions of no interest. Alternatively, the image may be enhanced for display, for example by increasing contrast or removing noise. The image may then be analyzed by CAD software to identify abnormalities, using one or more algorithms appropriate to the subject of the image. Examples of algorithms for performing such processing are described in the applicant's patent publications WO-A-05/114566, WO-A-05/112769 and WO-A-06/000738. The CAD algorithm may identify and mark the positions and/or extents of a specific type of suspected abnormality in the image. The output of a CAD algorithm is typically displayed using a viewer application, allowing the results of the CAD algorithm to be visualised and manipulated by the user in different ways. For example, the positions of suspected abnormalities may be highlighted in a view of the medical image, or the shape of a suspected abnormality may be displayed with three-dimensional graphics.

Standard formats and protocols exist for the storage and communication of medical images, medical image metadata, and the results of CAD analysis. One such standard is the Digital Imaging and Communications in Medicine (DICOM) standard, published by the National Electrical Manufacturers' Association (NEMA). Details of the DICOM standard were available on 15 Feb. 2006 at http://medical.nema.org/. The DICOM format includes Information Object Definitions (IODs) for communicating CAD results, including Secondary Capture Image (SCI) IODs.

Patent publication U.S. Pat. No. 25,169,508 describes a system for indicating whether a medical image has been pre-processed for image enhancement. If the image has been pre-processed, it is corrected prior to CAD analysis; in other words, the pre-processing is reversed.

Patent publication U.S. Pat. No. 6,909,795 describes a system in which CAD results are integrated in the pixels of a DICOM secondary image so that they are available at a viewing workstation.

The programme of the DICOM 2005 conference in Budapest, Hungary, Sep. 26-28, 2005, which was available on 15 Feb. 2006 at medical.nema.org/Dicom/DCW-2005/PROGRAM_DICOM-2005_International_Conference.doc, included an abstract for a presentation entitled “Issues Regarding Functional MRI Imaging Workflow and DICOM”, in which the authors report that “very few of the researchers and clinicians involved with functional MRI utilize DICOM formats for their intermediate results or final images. DICOM is merely used as a means to get the base data out of the scanners, which the researchers and clinicians routinely convert to one of several competing, non-DICOM formats for subsequent processing.”

### BRIEF SUMMARY OF THE INVENTION

According to one aspect of the invention, there is provided a method of performing CAD analysis of a medical image, wherein the medical image is processed in a first stage to generate intermediate result data, and the intermediate result data is processed at a second stage to generate CAD result data. The CAD analysis may involve more than two distinct stages, with each subsequent stage taking as input the intermediate result data of the previous stage. Different stages may be performed at different times, by different processing nodes or devices, and/or with different priorities. Each stage may further require one or more user-defined input parameters.

An advantage of embodiments of the invention is that they allow distributed CAD analysis. For example, processing-intensive earlier stages may be performed by medical image servers, and the results communicated to viewer workstations so that the final CAD results may be customized without requiring excessive processing power. Conversely, the earlier stages may be performed at an image capture location, and the intermediate data communicated to a CAD server for generating the CAD results without requiring the original medical image to be sent over a bandwidth-limited communications link.

If the medical image is stored in a DICOM format, the intermediate data may be stored as one or more Information Object Definitions (IODs) and preferably Secondary Capture Image (SCI) IODs. This ensures compatibility with the DICOM format without interfering with other uses of the format.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the pertinent art(s) to make and use the invention.

FIG. 1 is a schematic diagram showing a medical imaging device and a remote computer for processing image data from the medical imaging device.

FIG. 2 is a more detailed diagram of the remote computer according to an embodiment of the present invention.

FIG. 3 is a schematic diagram of a CAD processing method according to an embodiment of the present invention.

FIG. 4 is a diagram of a server-workstation architecture according to an embodiment of the present invention.

FIG. 5 is a diagram of a peer-to-peer architecture according to an embodiment of the present invention.

FIGS. 6 and 7 illustrate flowcharts of CAD methods according to embodiments of the present invention.

In the drawings, like reference numbers indicate identical or functionally similar elements. Additionally, the leftmost digit(s) of a reference number identifies the drawing in which the reference number first appears.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

### I. MEDICAL IMAGING

The present invention is applicable to digital medical images. One example of such an image is a computed tomography (CT) scan image. A CT scan image is a digital image comprising one or a series of CT image slices obtained from a CT scan of an area of a human or animal patient. Each slice is a 2-dimensional digital grey-scale image of the x-ray absorption of the scanned area. The properties of the slice depend on the CT scanner used. For example, a high-resolution multi-slice CT scanner may produce images with a resolution of 0.5-0.6 mm/pixel in the x and y directions (i.e., in the plane of the slice). Each pixel may have 32-bit greyscale resolution. The intensity value of each pixel is normally expressed in Hounsfield units (HU). Sequential slices may be separated by a constant distance along the z direction (i.e., the scan separation axis). For example, the sequential slices may be separated by a distance in a range of approximately 0.75-2.5 millimeters (mm). According to an embodiment, the scan image is a three-dimensional (3D) greyscale image, for example, with an overall size depending on the area and/or number of slices scanned. In another embodiment, the scan image includes a single slice represented as a single two-dimensional (2D) greyscale image.

Embodiments of the present invention are not limited to any specific scanning technique. For instance, the CT scan may be obtained by any of a variety of CT scanning techniques, including but not limited to electron beam computed tomography (EBCT), multi-detector or spiral scan, or any technique that produces as output a 2D or 3D image representing X-ray absorption.

Moreover, embodiments of the present invention are not limited to CT scan images, but may be applied to other digital medical images, including but not limited to magnetic resonance imaging (MRI), ultrasound, or X-ray images. Conventional X-ray images may be developed on an X-ray film prior to being digitized.

### II. COMPUTER SYSTEM

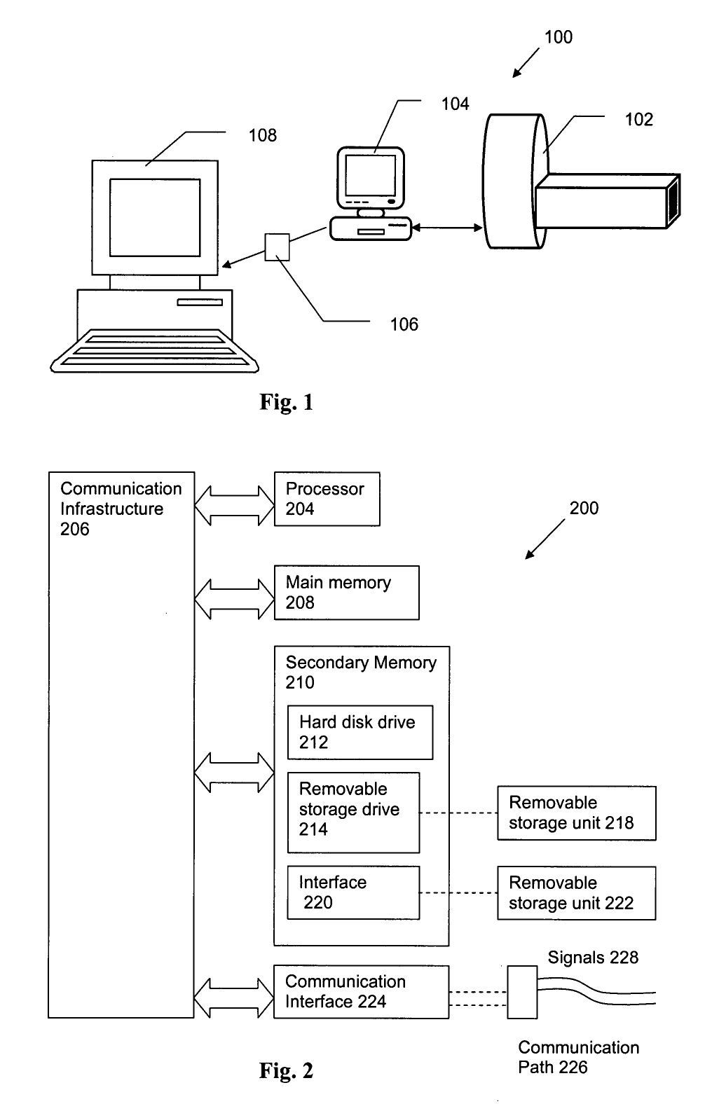

As shown in FIG. 1, the scan image may be created by a computer 104. Computer 104 receives scan data from a scanner 102 and constructs the scan image based on the scan data. The scan image is often saved as an electronic file or a series of files, which are stored on a storage medium 106, such as a fixed or removable disc. The scan image includes metadata associated with the scan image. The scan image may be analyzed by the computer 104, or the scan image may be transferred to another computer 108 which runs software for analyzing the scan image and/or displaying the results of the analysis, as described below. The software may be stored on a computer recordable medium, such as a removable disc or a solid-state memory, or downloaded over a network.

Each of the computers described herein may be any type of computer system, including but not limited to an example computer system 200 as shown in FIG. 2. Embodiments of the present invention may be implemented as programmable code for execution by the computer system 200. Various embodiments of the invention are described in terms of this example computer system 200. After reading this description, it will become apparent to a person skilled in the art how to implement the invention using other computer systems and/or computer architectures.

Referring to FIG. 2, computer system 200 includes one or more processors, such as processor 204. Processor 204 may be any type of processor, including but not limited to a special purpose or a general-purpose digital signal processor. Processor 204 is connected to a communication infrastructure 206 (for example, a bus or network).

Computer system 200 also includes a main memory 208, preferably random access memory (RAM), and may also include a secondary memory 210. Secondary memory 210 may include, for example, a hard disk drive 212 and/or a removable storage drive 214, representing a floppy disk drive, a magnetic tape drive, an optical disk drive, etc. Removable storage drive 214 reads from and/or writes to a removable storage unit 218 in a well-known manner. Removable storage unit 218 represents a floppy disk, magnetic tape, optical disk, etc., which is read by and written to by removable storage drive 214. As will be appreciated, removable storage unit 218 includes a computer usable storage medium having stored therein computer software and/or data.

In alternative implementations, secondary memory 210 may include other similar means for allowing computer programs or other instructions to be loaded into computer system 200. Such means may include, for example, a removable storage unit 222 and an interface 220. Examples of such means may include a program cartridge and cartridge interface (such as that found in video game devices), a removable memory chip (such as an EPROM or a PROM) and associated socket, and other removable storage units 222 and interfaces 220 which allow software and data to be transferred from removable storage unit 222 to computer system 200.

Computer system 200 may also include a communication interface 224. Communication interface 224 allows software and data to be transferred between computer system 200 and external devices. Examples of communication interface 224 may include a modem, a network interface (such as an Ethernet card), a communication port, a Personal Computer Memory Card International Association (PCMCIA) slot and card, etc. Software and data transferred via communication interface 224 are in the form of signals 228, which may be electronic, electromagnetic, optical, or other signals capable of being received by communication interface 224. These signals 228 are provided to communication interface 224 via a communication path 226. Communication path 226 carries signals 228 and may be implemented using wire or cable, fibre optics, a phone line, a cellular phone link, a radio frequency link, or any other suitable communication channel. For instance, communication path 226 may be implemented using a combination of channels.

In this document, the terms “computer program medium” and “computer usable medium” are used generally to refer to media such as removable storage unit 218, a hard disk installed in hard disk drive 212, and signals 228. These computer program products are means for providing software to computer system 200.

Computer programs (also called computer control logic) are stored in main memory 208 and/or secondary memory 210. Computer programs may also be received via communication interface 224. Such computer programs, when executed, enable computer system 200 to implement the present invention as discussed herein. Accordingly, such computer programs represent controllers of computer system 200. Where the invention is implemented using software, the software may be stored in a computer program product and loaded into computer system 200 using removable storage drive 214, hard disk drive 212, or communication interface 224, to provide some examples.

In alternative embodiments, the invention can be implemented as control logic in hardware, firmware, or software or any combination thereof.

### III. CAD PROCESSING

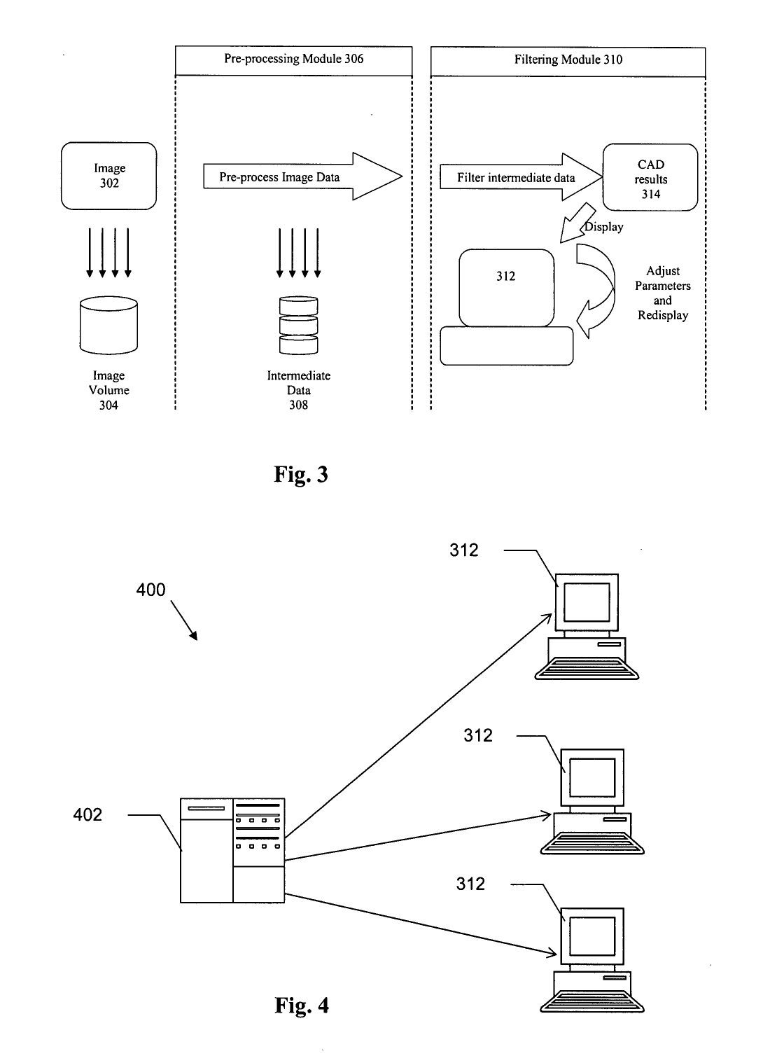

FIG. 3 shows schematically a method of CAD processing of a medical image using a DICOM format, according to an embodiment of the present invention. In FIG. 3, a digital medical image 302 is captured and stored together with image metadata in the DICOM format in an image volume 304. For example, computer 104 or 108 may capture and store the image 302 together with the image metadata in the image volume 304.

In a CAD pre-processing module 306, the image volume 304 is pre-processed and the intermediate results of the pre-processing are stored as intermediate data 308. The pre-processing preferably comprises various CAD processing components that are resource-hungry and/or do not require data other than the image volume 304.

In an aspect, the intermediate data are stored as DICOM SCI IODs as defined in the DICOM standard PS-3.3 (2004). The use of this format may facilitate the communication of the intermediate data between DICOM conformant systems, preferably without interfering with the storage of final CAD results. To comply with the DICOM standards, an SCI IOD contains some image data. However, the intermediate data need not necessarily include an image derived from the original image 302. For example, the intermediate data 308 may include a dummy image or an image containing some information not derived from the original image 302, such as a product logo.

In a CAD filtering module 310, the intermediate data 308 are processed to generate CAD filtering results 314. For instance, the CAD filtering results 314 may be displayed to an end user on a viewer workstation 312. The end user may provide parameter values for the CAD filtering module 310, which are used to generate the CAD filtering results 314. The user may modify the parameter values and re-run the CAD filtering module 310 on the intermediate data 308 using the new parameter values to generate a modified set of CAD filtering results 314. In this way, the filtering module 310 may be interactive, while the pre-processing module 306 may not be interactive and may be run as a batch or background process. The filtering module 310 may be run repeatedly with different input parameters on the same set of intermediate data 308 without having to re-load and/or re-process the original image volume 304 to generate the intermediate data 308. As a result, the time taken to re-run a CAD process with different input parameters is significantly reduced.

The exact nature of the CAD filtering results 314 may depend on the particular CAD application. For example, the CAD filtering results 314 may include any of a variety of data, including but not limited to coordinates of suspected abnormal regions (e.g., colonic polyps or pulmonary nodules), contours representing the outlines of these regions or other anatomical features, and/or feature information relating to measurements, degrees of confidence and/or classifications of the detected regions. The CAD filtering results 314 may be stored as DICOM IODs and communicated to another DICOM-compatible process if required.

According to embodiments, the CAD pre-processing module 306 and filtering module 310 are implemented as discrete programming libraries having defined application program interfaces (APIs) that allow the modules to be incorporated in CAD processing systems.

### IV. SYSTEM ARCHITECTURES

The CAD pre-processing module 306 and the CAD filtering module 310 are distributable, allowing adoption of a variety of different system architectures. In one embodiment, both modules 306, 310 are executed sequentially for each image volume 304 on the same viewer workstation 312 in a sequential fashion. The pre-processing module 306 may be activated manually by the user, or automatically based on metadata stored with the original image 302. The pre-processing module 306 may require no input from the end user, and may therefore be run as a background service that automatically pre-processes image volumes 304 as they arrive at the workstation 312. The filtering module 310 may be activated by the end user as required and may be used to perform filtering based on the pre-processed intermediate data 308.

In another embodiment, as shown in FIG. 4, the pre-processing module 306 is run on a pre-processing server 402 that receives captured medical image volumes 304 from computer(s) 104 and pre-processes the volumes 304 to generate corresponding sets of intermediate data 308. The corresponding sets of intermediate data 308 are then distributed over the Internet or an intranet to one or more viewer workstations 312, each running the filtering module 310 as described above. This arrangement removes the pre-processing burden from the viewer workstations 312. If a plurality of the viewer workstations 312 are to perform CAD on the same image, this architecture also reduces the need for a plurality of the viewer workstations 312 to pre-process the same image volume 304.

In an aspect, the architecture of FIG. 4 may enable a licensing model in which the pre-processing module 306 generates the intermediate data 308 in an encrypted form. In this aspect, the intermediate data may only be decrypted by licensed filtering modules 310, so that end users are required to obtain a license and receive a current decryption key in order to filter the intermediate data 308. In this way, payment may be obtained from the end users for use of the intermediate data 308, thereby funding operation of the pre-processing server 402.

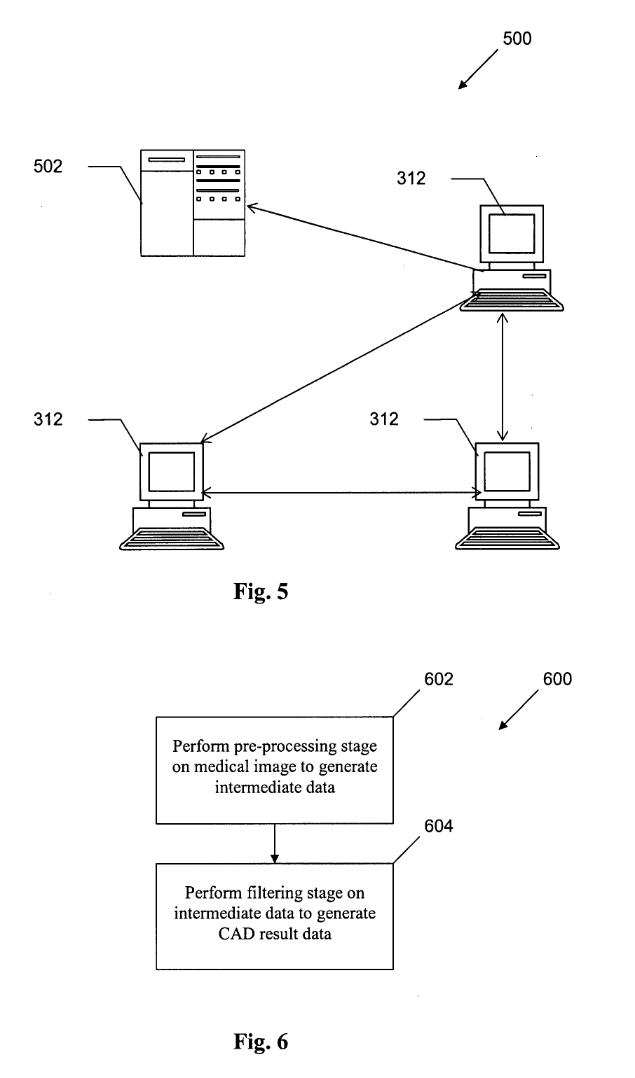

In yet another embodiment, as shown in FIG. 5, a plurality of viewer workstations 312 are interconnected in a peer-to-peer network, over an intranet or the Internet. In this embodiment, each viewer workstation 312 runs both the pre-processing module 306 and the filtering module 310. The intermediate data 308 from the pre-processing module 306 on one of the viewer workstations 312 may be distributed over the network to other ones of the viewer workstations 312 for filtering by their respective filtering modules 310. The intermediate data 308 may be transmitted to an intermediate data server 502 for storage and distribution, for example over a network as described with reference to FIG. 4.

In the embodiment of FIG. 5, the intermediate data 308 may be provided in an encrypted format, so that each filtering module 310 requires a decryption key provided under license, as in the embodiment of FIG. 4.

Various other architectures are enabled within the scope of the present invention. For example, the computer(s) 104 on which the image volumes 304 are captured may run the pre-processing module 306 and distribute the intermediate data 308 to an intermediate data server for onward distribution to viewer workstations 312, each running the filtering module 310. This arrangement may avoid the need to transmit the image volumes 304 over a network. For instance, just the intermediate data 308 may be transmitted.

### V. ILLUSTRATIVE FLOW CHARTS

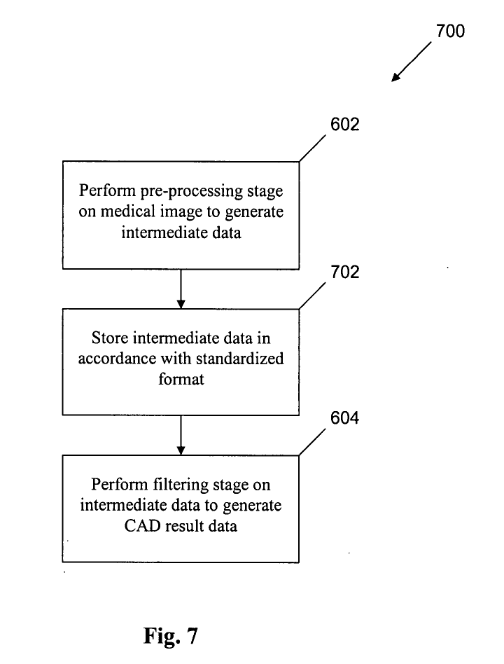

FIGS. 6 and 7 illustrate flowcharts 600 and 700 of methods of performing computer-aided detection (CAD) of abnormalities in a medical image according to embodiments of the present invention. The invention, however, is not limited to the description provided by flowcharts 600 and 700. Rather, it will be apparent to persons skilled in the relevant art(s) from the teachings provided herein that other functional flows are within the scope and spirit of the present invention.

Flowcharts 600 and 700 will be described with continued reference to example computer system 100, example server-workstation architecture 400, and example peer-to-peer architecture 500 described above in reference to FIGS. 1, 4 and 5, respectively, though the methods are not limited to those embodiments.

Referring now to FIG. 6, a pre-processing stage is performed on the medical image to generate intermediate data at block 602. A filtering stage is performed on the intermediate data to generate CAD result data at block 604. For example, any of computer 104 or 108, pre-processing server 402, intermediate data server 502, or work station(s) 312 may perform the pre-processing stage and/or the filtering stage. In the embodiment of FIG. 6, the pre-processing stage and the filtering stage are performed discretely.

FIG. 7 illustrates that the intermediate data can be stored in accordance with a standardized format at block 702. For example, computer 104 or 108, pre-processing server 402, intermediate data server, or a work station 312 may store the intermediate data in accordance with any of a variety of standardized formats, such as the Digital Imaging and Communications in Medicine (DICOM) secondary capture image information object definition (SCI IOD) format. In the embodiment of FIG. 7, the pre-processing stage and the filtering stage need not necessarily be performed discretely.

### VI. CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above described exemplary embodiments, but should be defined only in accordance with the following claims and their equivalents.

What is claimed is:

1. A method of performing computer-aided detection (CAD) of abnormalities in a medical image, comprising:
(a) performing a pre-processing stage on the medical image to generate intermediate data; and
(b) performing a filtering stage on the intermediate data to generate CAD result data;
wherein steps (a) and (b) are performed discretely.

2. The method of claim 1, wherein steps (a) and (b) are performed on respective discrete devices.

3. The method of claim 1, wherein step (a) is performed substantially without user interaction.

4. The method of claim 3, wherein step (a) is performed as a background process.

5. The method of claim 1, wherein step (b) is performed as an interactive process.

6. The method of claim 1, wherein step (b) is performed using one or more parameters provided by a user independently from the intermediate data.

7. The method of claim 6, wherein step (b) is repeated in response to modifying said one or more parameters by the user.

8. The method of claim 1, wherein step (b) is performed on a viewer workstation, the method further comprising displaying said CAD result data on the viewer workstation.

9. The method of claim 1, wherein step (a) is performed on a server and step (b) is performed on a workstation.

10. The method of claim 1, wherein steps (a) and (b) are performed at respective discrete nodes of a peer-to-peer network.

11. The method of claim 1, wherein step (a) is performed by a medical imaging station.

12. The method of claim 1, wherein performing the pre-processing stage includes encrypting the intermediate data, and wherein performing the filtering stage includes decrypting the intermediate data.

13. The method of claim 1, further comprising:
(c) storing the intermediate data in a DICOM format.

14. The method of claim 13, wherein storing the intermediate data includes storing the intermediate data as an information object definition (IOD).

15. The method of claim 14, wherein the IOD is a secondary capture image (SCI) IOD.

16. An article comprising a medium having instructions stored in said medium for causing a processor-based system to perform computer-aided detection (CAD) of abnormalities in a medical image, comprising:
a first instruction that causes a first discrete processor to perform a pre-processing stage on the medical image to generate intermediate data; and
a second instruction that causes a second discrete processor to perform a filtering stage on the intermediate data to generate CAD result data.

17. An apparatus configured to perform the method of claim 1.

18. An apparatus to perform computer-aided detection (CAD) of abnormalities in a medical image, comprising:
means for performing a pre-processing stage on the medical image to generate intermediate data; and
means for performing a filtering stage on the intermediate data to generate CAD result data;
wherein the means for performing the pre-processing stage and the means for performing the filtering stage are configured to perform the respective pre-processing stage and filtering stage discretely.

19. A network system for performing computer-aided detection (CAD) of abnormalities in a medical image, comprising:
(a) a first network node arranged to perform a pre-processing stage on the medical image to generate intermediate data; and
(b) a second network node arranged to perform a filtering stage on the intermediate data to generate CAD result data.

20. A method of performing computer-aided detection (CAD) of abnormalities in a medical image, comprising:
(a) performing a pre-processing stage on the medical image to generate intermediate data;
(b) storing the intermediate data in accordance with a Digital Imaging and Communications in Medicine (DICOM) secondary capture image information object definition (SCI IOD) format; and
(c) performing a filtering stage on the intermediate data to generate CAD result data.
